(19) United States
(12) Patent Application Publication
(10) Pub. No.: US 2015/0058129 A1
(43) Pub. Date: Feb. 26, 2015

(54) SYSTEM AND METHOD FOR ELECTRONIC INTERACTION WITH MERCHANDISING VENUES

(71) Applicant: MARSHALL FEATURE RECOGNITION LLC, Marshall, TX (US)

(72) Inventors: Jeffrey S. Nevid, New York, NY (US); Spencer A. Rathus, Surfside, FL (US)

(73) Assignee: MARSHALL FEATURE RECOGNITION LLC, Marshall, TX (US)

(21) Appl. No.: 14/459,258

(22) Filed: Aug. 13, 2014

Related U.S. Application Data
(60) Provisional application No. 61/869,145, filed on Aug. 23, 2013.

(51) Int. Cl. G06Q 30/02

(52) U.S. Cl. CPC G06Q 30/0269; G06Q 30/0267
USPC 705/14.64

(57) ABSTRACT

The disclosed systems and methods refer to electronic interaction between a consumer and one or more merchandising venue systems in order to personalize and enhance the shopping experience. The interaction begins automatically upon consumer arrival at or near a venue. A consumer profile may be used to tailor programming material transmitted by the merchandising venue system.

### CROSS-REFERENCE TO RELATED APPLICATIONS

This application claims the benefit of Provisional Application No. 61/869,145, filed Aug. 23, 2013, the entire contents of which are herein incorporated by reference.

### BACKGROUND OF THE INVENTION

The Internet has changed many aspects of contemporary life, including commerce. People today routinely use online services to order movie tickets, plan vacations, search for property, obtain news, engage in research, and shop. They use online search engines to obtain product information. Search engines allow them to specify the products, brands, and features they seek without sifting through traditional product catalogues or navigating through a merchant's website. Bricks-and-mortar merchants also face the challenge of “show-rooming,” in which consumers visit stores to look at merchandise but purchase it less expensively through online vendors. Consumers equipped with barcode scanning cell phones can obtain comparison pricing information and product reviews by scanning barcodes on product packaging in stores and then use that information to find competing stores or online vendors that offer the same merchandise at lower cost. The downloading of single songs and e-books has led to the virtual demise of “record stores” and bookstores.

Also, merchandising venues such as big box stores and department stores may offer thousands of items for sale, but they face the challenge of consumer frustration as consumers try to find their way to merchandise or services of interest, perhaps with the help of floor sales personnel. Locating items of interest may be a cumbersome, time-consuming, and inefficient task, in contrast to the more targeted search options available through online search engines.

In order to lure shoppers away from their computer screens, brick-and-mortar stores are retooling to try to make shopping more interactive, customized, and personalized. Thus it would be advantageous to provide incentives to bring consumers to merchandising venues or commercial establishments, and to provide in-venue consumers more efficient means of surveying inventory and identifying merchandise or services of interest. A central object of the present invention, then, is to efficiently align the need of merchants and consumers. The disclosed system and methods enable merchants and consumers to readily exchange electronic information to identify, locate, and promote merchandise or services of interest.

Existing technologies allow consumers to use their electronic devices, such as smart phones, to recognize or scan machine recognizable features such as barcodes on advertisements or product packaging to retrieve programming material about the products. However, consumers must first find the advertisement or merchandise before they can interact with the barcodes or other machine recognizable features. Advantageously, the present invention obviates the need for consumers to physically locate merchandise of interest, or to physically interact with advertisements before obtaining additional electronic information. It enables consumers to interact with merchandising venues such that the venues transmit desired electronic data or programming material to the consumers' communication devices. Moreover, the data can be tailored to consumers' profiles, preferences, and needs.

Means for establishing a user profile based on consumer preferences, activity, or purchase behavior, as in the following group of patents, are well known. However, they are generally limited to online applications. For example, Gottfurcht et al. (U.S. Pat. No. 8,452,653, 2013) reveal means of using a consumer/user profile to provide product recommendations to a consumer/user. The consumer/user profile comprises a compilation of consumer/user activity, including purchasing activity, and recommendations are provided when the consumer/user accesses an online service. Similarly, Linden et al. (U.S. Pat. Nos. 8,433,621 and 8,407,105, both 2013; U.S. Pat. No. 7,970,664, 2011; and U.S. Pat. No. 6,912,505, 2005) reveal means of using consumer/user behaviors such as viewing products in an electronic catalog and making item purchases, as well as consumer/user search and browsing activities, to generate personalized item recommendations for consumer/users. Dicker et al. (U.S. Pat. No. 8,370,203, 2013, and U.S. Pat. No. 7,720,723, 2010) disclose means for generating product recommendations to individuals in an online retailing environment based on such attributes as consumer/user purchase history. Dicker et al. (U.S. Pat. No. 7,720,723, 2010) also disclose means of providing recommendations to a consumer/user of an electronic catalog based on consumer/user activity involving adding items to an electronic shopping cart. Snodgrass et al. (U.S. Pat. No. 7,827,055, 2010) disclose means of present recommendations to consumer/users of an online retailing service based on referring sites accessed by such consumer/users. Earlier, Kalagnanam et al. (U.S. Pat. No. 6,873,967, 2005) disclosed an online shopping system that assists shoppers in selecting products from different online stores that match their preferences and budget constraints. Again: these patents are limited to online applications.

Other online applications for providing product recommendations include Harbick et al. (U.S. Pat. No. 8,260,656, 2012), who disclose a data mining means for providing consumer/users of an online service recommendations on works such as music downloads and electronic books based on consumer/user characteristics derived from previous online download activity or playlists recorded on a consumer/user device. Similarly, Ortega et al. (U.S. Pat. No. 8,260,771, 2012) reveals means by which online search methods can be refined on the basis of consumer/user attributes, including consumer/user online activity. Jacobi et al. (U.S. Pat. No. 8,024,222, 2011; U.S. Pat. No. 8,140,391, 2012; U.S. Pat. Nos. 7,945,475 and 7,921,042, both 2011; U.S. Pat. No. 7,113,917, 2006; and U.S. Pat. No. 6,317,722, 2001) disclose means of providing recommendations of items in an electronic catalogue based on user purchasing behavior and other behavior data. None of the aforementioned disclosures teaches means of providing users with tailored product recommendations in an actual merchandising venue or commercial establishment, such as a store, or means by which data transmitted by a server or other device in a venue is filtered through a set of user defined criteria to ascertain matches of relevant electronic programming. Donsbach et al. (U.S. Pat. No. 8,122,020, 2012, and U.S. Pat. No. 7,668,821, 2010) reveal means by which users can tag items in an electronic catalogue and receive recommendations based of items that are similar to those that are tagged. But none of these aforementioned disclosures reveal means of matching retrieved electronic content in a real merchandising venue or commercial establishment, such as a retail store, to a user profile.

Abbass et al. (International publication No. WO 2008103587 A3) and Kern et al. (U.S. Patent application publication No. 20080208705 A1) do disclose means of using a user profile to provide a shopper with a purchasing recommendation. As in other forms of online shopping, the shopper requests the recommendation “over a public network.” However, the Abbass art is aimed at making purchasing recommendations for consumers who “wish to purchase a gift for a particular recipient and wish to purchase one that the recipient is likely to appreciate and enjoy, but are uncertain about how to go about identifying such as gift.” The profile information in the Abbass art is about the potential recipient of a gift, not about the shopper.

A prior example of an application in a retailing environment is Avallone et al. (U.S. Pat. No. 7,856,368, 2010), which reveals means of delivering personalized electronic information to patrons, such as a shopping list or promotional offers or sales of particular items, by use of in-store portable display units that can access information tailored to particular users on the basis of user characteristics stored in a database. However, the system as described requires users to activate and operate a shared portable display device of the store to retrieve pertinent information. The present invention advantageously leverages the consumer's own personal communication device to obviate the need for using a shared in-store device, and also leverages the venue's use of consumer proximity to transmit electronic information that is matched to the consumer's profile.

Ogasawara (U.S. Pat. No. 6,123,259, 2000) discloses a shopping system comprising communication between a store computer and a mobile terminal that provides shoppers with directions to the location of merchandise that corresponds to shopping lists shoppers have prepared and transmitted to the store computer. Similarly, Figueroa et al. (U.S. Pat. No. 8,150,741, 2012) disclose an in-store shopping assistant that provides more efficient travel routes to locate user-requested merchandise items. Johnsen (U.S. Pat. No. 5,250,789, 1993) reveals a shopping cart used for displaying and organizing a shopping list coordinated with the location of products in a store and displaying information regarding products that are scanned. None of these disclosures reveals means of transmitting product information tailored to consumer preferences and based on consumer proximity to a merchandising venue or commercial establishment.

Similar limitations are found in the following disclosures: Swix et al. (U.S. Pat. No. 8,132,202, 2012) discloses means of providing targeted advertisements over a networked media delivery system based on tracking and storing viewer selections. Flusser et al. (U.S. Pat. No. 8,260,684, 2012) disclose means of providing online recommendations of clothing items for matching apparel and accessories in a virtual wardrobe based on generating a coordination score. The disclosure does not reveal means of applying user-based criteria (preferences, past shopping history, demographic characteristics) to determine product recommendations, nor does it apply to identifying users based on proximity location in a retailing environment. Brown et al. (U.S. Pat. No. 7,822,635, 2010) disclose means of providing specialized services and products based on consumer/user preferences transmitted from a user data processing system to a multiple, independent server system. However, the disclosed means and apparatus are limited to online systems.

Tuchman et al. (U.S. Pat. No. 7,658,327, 2010) disclose an information system comprising an in-store wireless kiosk, which a shopper uses to obtain assistance from a virtual sales agent, tailored to user characteristics housed in a database comprising such factors as past purchasing behavior. The communication system is so enabled as to permit predictions of consumer interests or information that may be of interest to the consumer. Consumer location in the retail store is also used to predict consumer preferences. However, the disclosure does not present means for transmitting information to a consumer without using a store kiosk.

Narayanaswami et al. (U.S. Pat. No. 7,890,434, 2011) disclose means of selling items in a shopping venue, but unlike the present invention, their method and apparatus require a user to transmit a signal comprising a list of items of interest. Unlike the present invention, the disclosure does not reveal means of correlating a consumer profile to electronic information.

Raimbeault (U.S. Pat. No. 7,974,889, 2011) discloses an interactive shopping cart for displaying in-store product advertising based on prediction of a user's response derived from real-time or historical purchases and also discloses means of displaying advertising messages personalized to a user's social and shopping history and patterns of behavior. Means are also disclosed for a consumer's uploading of a user profile to a social networking page, which then can be displayed during the shopping experience in order to access user generated shopping lists and preferences. However, the disclosure does not involve proximity location services nor does it enable a consumer's communication device as a means for retrieving and displaying product information.

Mowry (U.S. Pat. No. 8,249,924, 2012) discloses a method for displaying advertising information of relevance to a first user and displayed on the user's computing device. The disclosure does not reveal means of location identification of user within a merchandising venue or means of providing product for sale information relevant to user preferences or profile.

Lin et al. (U.S. Pat. No. 8,239,276, 2012) provide a means by which a user generates an on-the-go shopping list by scanning items in a store. The user scans products to create an electronic shopping list. Lin et al. also disclose a means of compiling a user profile. The disclosure is limited to compiling a shopping list stored in an electronic device by compiling product identifiers corresponding to products to be purchased. The method and system are limited to providing information correlated with a shopping list, and they require a user to scan items.

Suzuki (U.S. Pat. No. 6,129,274, 2000) discloses use of in-store kiosk (a “customer assistance terminal,” but importantly, not a user communication device) for retrieving product information relating to customer shopping history or profile (e.g., dress size). Such profile data is stored in a loyalty-type, machine-readable smart card, which interacts with a store's checkout terminal to provide promotional and personalized greeting messages to a user. However, the patent is limited to an in-store system interaction of a customer at a point of sale terminal and involves a method of reading a smart card at a checkout terminal. The present invention, by contrast, discloses means for accessing information correlated with a user profile that do not require the user to interact with a card reader at a checkout terminal.

Sloan (U.S. Pat. No. 6,434,530, 2002) discloses “a shopping system for use in a shopping venue.” However, the disclosure does not provide means of using a user-generated profile to match content retrieved to user preferences and background; nor does it disclose means of providing product for sale information tailored to said user preferences, or means by which such information can be obtained without the need for a user interacting with a selected product by means of scanning a product bar code.

Holzman (U.S. Pat. No. 7,156,303, 2007) discloses a shopping system that allows for identification of shoppers by means of an RFID identifier and for processing payments at the checkout counter, not as a means of surveying a user profile to retrieve correlated product information.

Christensen (U.S. Patent application publication No. 20120203572) discloses “A Point-of-Entry Kiosk loyalty system, couponing system, and shopping list system” such that when a consumer enters a store, kiosk(s)s may be present for consumer check-in. The consumer may swipe a coded loyalty card, enter their loyalty number or data may be automatically entered through RFID technology or smart phone. The consumer may be presented with discount or coupon offers or shopping suggestions, which may be based on the consumer's prior preferences, demographic data, prior purchases, or preference data harvested from various social networking sites, search engines, or other websites used by the consumer.” However, Christensen does not disclose means of a user creating a user profile for use in correlating retrieved information; moreover, the disclosure is limited to means by which a user interacts with a store kiosk.

Tang et al. (U.S. Patent application publication No. 20070259653) disclose means by which a user's communications can be recognized by a nearby communications detection device, coupled with a service capable of retrieving information when the user device is in the proximity of the communications detection device. Content delivered is targeted to the user's space. Tang et al. provide a means of using a proximity-based application to request information from a client and providing a form for the client user to complete. However, the inventors' method and systems are limited to electronic identification of a communication device. They do not disclose correlating retrieved content to a previously registered user profile.

Do (U.S. Pat. No. 7,178,722, 2007) discloses means of proximity location by detecting a wireless transmission from a shopper's device. Location-specific advertising is then transmitted to the shopper. However, the method and system is based on geographic proximity to items for sale. It does not teach retrieval of content based on matching products for sale to a user generated profile, nor using proximity location to a merchandising venue for purposes of delivery of product information about merchandise and services throughout the venue.

A patent (U.S. Pat. No. 7,890,434, 2011) and a patent application (U.S. patent application publication No. 20080059341) by Narayanaswami et al. disclose a portable shopping device used in selling items in a shopping venue, but requiring a user to transmit a signal comprising a list of items of interest and then returning information to the user regarding the availability of an item of interest. By contrast, the present invention does not require users to transmit signals corresponding to items of interest. Moreover, the information returned in the cited Narayanaswami disclosures does not match the information to a user profile.

Thornton (U.S. Pat. No. 8,461,995) discloses a mobile device as reading a plurality of electronic tags associated with merchandise, transmitting the information in the tag to a server, the server then selecting an advertisement based on what the merchandise has in common, and transmitting the advertisement to the display of the user. The user can then engage in various actions concerning the advertisement, including communicating with store personnel. The present invention, however, does not involve reading tags associated with merchandise. Instead, the venue transmits programming material based on the consumer's profile to the consumer.

Geier (“Deploying Indoor WLAN Positioning Systems”, Wi-Fi Planet, Oct. 23, 2002, www.wi-fiplanet.com/tutorials/article.php/1487271) discusses the use of wireless LAN (WLAN) applications in shopping malls or large retail stores. He notes that using them will enable the delivery of electronic flyers and advertisements. However, his suggested method relies on the location of shoppers within the facility and delivers advertisements based on their locations. The present invention, by contrast, advantageously bases the content of delivered programming material on the consumer's profile or expressed shopping interests rather than on his or her location within the venue. In the present invention, wireless LAN is only one of the positioning methods by which consumers can be directed to the merchandise of interest.

Norliza et al (International publication No. WO 2011005072 A3) disclose a system for providing purchasing information to a user based on the creation of a list of preferences or on purchasing history. When the shopper requests a purchasing recommendation, a server considers the user profile and the user's current context and makes such a recommendation. Chandlee (International publication No. WO 2002037366 A2) discloses the creation of a personalized shopping list based on a user's purchasing history, but the method is limited to calculating likelihoods that users will be “running out” of various products, such as groceries. In contrast to these disclosures, the present invention is proactive; it enables a merchandising venue to gain access to a user profile and transmit electronic data about merchandise and services related to said profile upon user entry to the venue.

Dessert et al. (U.S. Patent application publication No. 20130181045 A1) disclose a personalized shopping system that involves “checking in” to a commercial establishment with a portable computing device, which may verify user's credentials to grant them access to “a central payment controller” and provide them with an identifier from a merchant. As a result, when the user scans a machine-readable code associated with a “good or a service,” he or she can receive information associated with the good or service from a database. This disclosure would appear to actually be a step backward from art that enables the receipt of information upon such scanning without the intervening step of registering. Moreover, the present invention advantageously delivers programming material related to venue merchandise and services upon user entry to the venue. The information delivered, in the present invention, is based on the user profile and a database containing encoded information about available merchandise and services. In the present invention, no user scanning is required or necessary.

Burazin at al. (International publication No. WO 009077888 A1) disclose a personalized shopping system that provides in-store information including, but not limited to, advertisements. The system takes “one or more preferences or parameters of the shopper into account,” and provides sources of information the store “at various opportunities based on the shopper's media preferences.” “For example” note the inventors, “the computing device(s) may send appropriate signals to an audio speaker near the display to provide an audio advertisement or message.” The present invention, advantageously, delivers the programming material directly to the user's own device, such that reception of information is independent of the user's location in the venue.

Kim et al. (U.S. Pat. No. 8,751,428, 2014) disclose a location-based method for detecting a user's communication device in a particular service entity, such as a restaurant or amusement park, whereupon information about the entity, such as restaurant menus, is transmitted to the communication device. The information is not personalized to the user's profile or purchasing history. Upon entering a service venue, the user may set his or her device to search for service information. The present invention advantageously permits the user to signal a merchandising venue to access the user's stored profile so as to personalize the information received.

Roeding et al. (U.S. Pat. No. 8,489,112, 2013), as Kim, disclose location-based sensing method of detecting a user's communication device in a particular setting, such as a retail venue. Rewards or coupons, which may be personalized to the user's profile or shopping history, are transmitted to the user's communications device. The present invention does not rely on means of determining the user's location, but rather the user chooses whether or not to turn the system “on” when in or near a merchandising venue of interest. But when the system is set in a ready position, or turned on, and the merchandising venue or commercial establishment is within range, the system automatically initiates communication between the user's communication device and the venue. Consequently, and advantageously, the consumer opts into using the system. In the case of Kim, the user receives information associated with the venue (such as menus in a restaurant) but the information is not personalized to the user. The present invention also describes means by which the user establishes a user profile that is then stored and made accessible to a particular merchandising venue or commercial establishment, whereas in Roeding the venue targets individual consumers based on parameters it establishes as representing the user's interests and probable products of interest.

### SUMMARY OF THE INVENTION

The current invention has capabilities that are improvements both to the personalized-shopping field and to the prior art. According to the present invention, the present invention provides methods and system by which a consumer/user can initiate interaction with a merchandising venue or commercial establishment system to obtain desired programming material related to merchandise and/or services. The programming material can be personalized or tailored to the consumer's needs, preferences, and characteristics by means of a consumer/user profile. The profile may be completely or in part created by the consumer and comprise a list of consumer needs and/or preferences, a history of the consumer's shopping and purchasing history, and any combination thereof. The consumer's profile can be pre-existing in a third party's database, such as that of a bank, a credit card company, or a service provider. The profile can be stored in a memory associated with the consumers' communication device. The profile can also be stored in a database associated with the merchandising server of the merchandising venue or commercial establishment system. It can be created by the consumer alone or by the consumer's interacting with a third party, or with the merchant. The processor of the merchandising server can tailor the electronic data or programming material that is transmitted to the consumer, based on the consumer or user profile. Alternatively, the consumer can tailor the data he or she will accept, using a processor associated with his or her device. Either the consumer or the merchant, or both, can enlist third parties to upload or supply the consumer profile on demand, to transmit the programming material related to the merchandise or service, to tailor the programming material to the user (consumer) profile, and any combination thereof. In an alternative embodiment, no user profile is required.

The present invention also discloses means to respect the privacy of the consumer, and to avoid “bombarding” the consumer with unwanted information. Merchants can educate consumers about the existence of the merchandising venue system through which they can obtain electronic data or programming material about merchandise or services of interest in their merchandising venues. Then the consumer chooses to use the systems and methods disclosed in the present invention to learn about:
the availability of merchandise or services of probable interest to them;
the location of this merchandise or service in the merchandising venue or commercial establishment;
additional information about the merchandise or service;
promotions and discounts;
the ability to purchase the merchandise or service electronically; and
the ability to have the merchandise shipped to a location of their choosing.

Interested consumers choose whether or not to acquire the hardware and software on their devices that will enable the system and methods of the present invention. The consumer chooses whether or not to turn the system “on” on his or her device when in or near a merchandising venue of interest. But when the system is set in a ready position, or turned on, and the merchandising venue or commercial establishment is within range, the system automatically initiates communication between the user communication device and the merchandising venue system.

One object of the present invention, then, is the provision of a system and method to provide personalized electronic data or programming material about what is available to a consumer (user) when he or she arrives at, or in the vicinity of, a merchandising venue or commercial establishment, such as a store, a retail store, a clothing store, a department store, a grocery store, a supermarket, an electronics store, an office supplies store, a convenience store, a museum, a gallery, a restaurant, a bookstore, a wholesale distributor, a retail distributor, a theater, a stadium, and any combination thereof.

A related object of the invention is the provision of a system and method to provide personalized electronic data or programming material about what is available to a consumer when he or she arrives at, or in the vicinity of, a plurality of commercial establishments, as at a shopping mall, a town or village commercial district, or a street with several shops, such as Via Condotti in Rome or Fifth Avenue in New York City.

A related object of the invention is to provide consumers, or users of the system, with electronic data or programming material about merchandise and/or services, said programming material comprising advertising, information about the availability of merchandise or services, the location of the merchandise or service in the merchandising venue, additional information about the merchandise or service, information about related merchandise or services, information about discounts and promotions, information about the purchase and/or delivery of merchandise, contact information, and any combination thereof. The services include but are not limited to styling; salon services such as makeup, nail trimming and coloring, hair cutting and coloring, massage, and waxing; personal shopping; health-related services such as medical services, dental services, psychological services, nursing services, social work, and chiropractic services; athletic training, coaching, yoga, and Pilates; dance instruction; legal services; accounting services; child care services; laundry and cleaning services; travel services, including advisement and booking reservations; real estate services; food services; dietary services; rest rooms; appraisals; language services; financial services; check-cashing services; business services such as secretarial services, copying, printing, faxing, scanning, wrapping, mailing, emailing, telephony, computer use; gift wrapping; financing purchases; returns; interior decoration; landscaping services; repair services; tailoring services; tutoring and other educational services; career advisement and training services; religious services; chapel services; entertainment services; and vending machines; and any combination thereof.

A related object of the invention is a system and method for a merchandising venue's provision of individualized merchandise- or service-related information to consumers once consumers are within, or in proximity to, the venue.

Yet another object of the invention comprises a system and method for enabling bilateral communication between (i) a server in, or associated with, a merchandising venue or commercial establishment, and (ii) a consumer device, once the consumer has enabled the device to receive and transmit communications with the venue and initiated an interaction.

Still another object of the invention is a software application (an “app”) that enables bilateral electronic communication with a merchandising venue or commercial establishment system, using a consumer's communication device, as long as the consumer's device has means associated therewith to transmit electronic messages to the merchandising venue system and receive and display electronic messages received from the merchandising venue system. The “app” can also be built into, or downloaded into, a device given to the consumer by the venue, such as, but not limited to, a smart card or a smart phone.

A related object of the invention is the establishment of a means by which a consumer's communication device signals a merchandising venue or commercial establishment system that the consumer is either in, or in the proximity of, the venue and also agrees that the venue may transmit electronic data or programming material to his or her communication device. The present invention uses a consumer communication device to automatically initiate communication with the venue or establishment system when the consumer is in, or in the vicinity of, the venue. To receive communications from, and to transmit communications to, the merchandising venue system, the enabling software or “app” installed on the device is set on the “on” or “ready” position. When the consumer also has created and stored a user profile, the “app” enables the merchandising venue system to access the user's profile, enabling the merchandising venue system to transmit personalized programming material to the consumer.

Alternatively, the consumer may forward his or her profile to the merchandising venue system. If the profile is stored in the consumer communication device, the consumer uploads to profile to the merchandising venue system as part of the initiation of an interaction. In this embodiment, if the profile is stored by the merchandising venue system or in a third-party server or database, the consumer transmits a coded command to the merchandising venue system or the third party database to forward the profile to the processor of the venue.

It may also be that the consumer has enrolled in a loyalty or similar program with the merchandising venue or commercial establishment system. Information about consumer enrollment can be stored in the user communication device, a server or database associated with the venue, or a third-party database. Upon arrival at the merchandising venue, or its vicinity, communication is established between the user communication device and the merchandising venue system through the transmission and reception of electronic signals and data between them. The loyalty information serves as consumer agreement to receive programming material from the merchandising venue system and also provides the consumer with information, discounts, promotions and the like that may not be available to other consumers.

Another related object of the invention is the establishment of at least one station associated with a merchandising venue or commercial establishment for receiving messages from consumers indicating that they are present, and identifying them. Programming material may be transmitted to the consumer from this station or from at least one other source.

Another object of the invention is the tailoring of merchandise- or service-related information to a consumer or user profile, said profile comprising elements such as consumer preferences and needs, personal characteristics, demographic factors, shopping history, purchasing history, and any combination thereof.

There are many ways to construct user or consumer profiles and/or preferences that can be used to tailor the information the consumer receives. The present invention is not dependent on any one such method, but here are several illustrative examples. These methods generally request that the user of the system provide answers to a series of questions in building a consumer profile. There may be questions about one's clothing preferences—sizes, colors, styles, pricing limitations, and the like. There may be questions about one's health (conditions, medications, weight, and the like). Similarly, there may be questions about religious preferences, political preferences, sports preferences, travel and vacation preferences, and preferences in a romantic partner, dating partner, or sex partner. The profile-building agent or program extracts key words and phrases from these preferences and uses them to construct a profile comprising such information as consumer preferences, interests, activities, demographic characteristics, and purchasing behavior, in order tailor the incoming information.

Another way to build a profile and/or set of preferences is to present the consumer with a series of key words and phrases about merchandise and ask the consumer to rate them, for example, from “not-at-all important” to “extremely important.” As examples, a consumer could rate words and phrases such as the following as extremely important”: “teak furniture,” “costume jewelry,” “electronics,” “mini tablets,” “sports jackets,” “running supplies and equipment,” “weight control dog food,” “antacids,” and so on. The methods and system in the present invention might then limit the electronic data transmitted to the consumer device to programming material having at least one of these key terms, and might rank them according to their importance and the number of “hits”—that is, the number of key terms accessed in the programming material, along with the consumer's rating of the importance of these terms. If the merchandising venue system is also aware of the user's purchasing history, the merchandising venue system could select only programming material that fits with both the consumer's expressed interests in merchandise or services and his or her buying history.

In yet another method to create a user profile, a merchandising venue system or a system of a third party service, having access to communicate with a user device, identifies the user associated with the device and retrieves and compiles information concerning the user's purchasing behavior or other behaviors, demographic information, memberships in organizations, work history, family characteristics, educational and work history, and other consumer-related data. Thus, a user profile may be created, completely or in part, without direct user input.

Semantic technology can be used to integrate data from a plurality of consumer profiles, even though the methods of encoding and organizing data in each profile might differ. By using semantic technology, a merchant or a merchant's service provider can provide a deeper and more precise packet of programming materials to the consumer.

Another method of communicating approaches to tailoring electronic data or programming material is a simple override by the consumer to enter key terms into the profile and/or set of preferences “on the fly.” On a given day, the consumer may want to learn about the availability and pricing of new furniture, even though he or she has not purchased furniture in years or entered any suggestion of interest in furniture into his or her profile. He or she might load the “app,” select an option to enter an overriding term or terms, and key in “dining room furniture” or the like. Or a friend might have said, “You really need a Brand X handbag,” so the consumer keys in “Brand X” or “Brand X handbag.” The consumer can specify only Brand X or accept electronic data or programming material about similar brands. Upon opening the app, the consumer can have the option of seeing and editing keywords in memory and governing incoming programming material. The app might also query the consumer as to whether it should retain newly entered key terms in memory when the consumer closes the app. It is another object of the invention for consumers to be able to engage in a useful electronic interaction with systems of the merchandising venues without the creation and storage of a consumer profile. The consumer without a profile can simply enter his or her key terms at, or within communications range of, the merchandising venue or commercial establishment. An alternative software program or application (“app”) might present only this option—that is, that the consumer not create a user profile and, instead, use key terms to enable merchandising venues system to tailor incoming programming material. The app might maintain the key terms in memory until the consumer replaces them or deletes them.

As noted, the consumer profile may be stored in a consumer device, such as a mobile communication device, a cellphone, a smart phone, a computer, a tablet computer, a mini tablet computer, a handheld device, a wireless device, virtual reality (VR) glasses, a wearable computing means, and any combination thereof. Alternatively, the consumer profile may be stored in a server or database of the merchandising venue or commercial establishment system, such that when the consumer (i) enters the venue, or in the proximity of the venue, and (ii) by having the software “on” indicates that the merchandising venue system has permission to engage in communication, the merchandising venue system uploads the consumer profile and tailors its transmission accordingly. The merchandising venue system would also receive “override” instructions from the consumer and consequently transmit programming material related only to the overriding term or terms. The consumer profile can also be stored in a third party's server or database. Third parties can comprise credit card companies, banks, and service providers. A service provider would be an outside provider of the systems and methods disclosed in the present invention.

It is therefore a related object of the invention to establish the use of service providers who can assist merchandising venues or commercial establishments in setting up programs for engaging in the kinds of interactions with consumers that are disclosed in this document. Such service providers can assist the venue by creating and uploading the “apps” that consumers can download, by helping in devising templates for creating programming material and transmissions, by tailoring these transmissions to consumer profiles, by analyzing consumer behavior, by trouble-shooting, and any combination thereof.

Another object of the invention is the creation of a smart card or similar device that will (a) alert a commercial establishment system to the proximity of a consumer, (b) identify the consumer, (c) store a consumer profile within the card or provide links to said consumer profile which may be stored remotely. The smart card may have a display unit on its surface such that electronic data or programming material transmitted by the establishment system is displayed on the card, or the electronic data may be displayed on another device available to said consumer. Said another device may comprise a consumer's mobile phone, another handheld device, or a device of the establishment.

Yet another object of the invention is a system and method for allowing a commercial establishment system to provide information displayed on a consumer's wireless communication device regarding sales promotions and features, costs, and store locations of particular products for sale.

Yet another object of the invention is a system and method for allowing a consumer in a commercial establishment to establish contact with sales personnel who can assist the consumer in examining and purchasing products and/or services. In some embodiments, the link labeled “Contact Us” will have requesting a sales person as one of several options. Other options under “Contact Us” include but are not be limited to “Call,” “Email us,” “Text us,” and “Chat with us.” The sales person can locate the user by means of location positioning.

Still another object of the invention is a system and method for enabling a consumer in a merchandising venue or commercial establishment to agree that by initiating electronic interaction with the merchandising venue system, the merchandising venue system has permission to access his or her user profile.

Yet another object of the invention is merchant use of an across-the-board discount for consumers who use the system and method disclosed in the present invention. Specifically, the merchandising venue system can inform any cashier and/or cash register to provide the across-the-board discount when the consumer makes a purchase. This discount would be “above and beyond” any promotional material related to specific merchandise or services at time of purchase. For example, the consumer may have received a transmission to the effect that he or she is eligible for a 30% discount on any Michael Kors clothing purchased “today or tomorrow.” However, there would also be the discount for using the system and method, perhaps 3%, such that the final price would be 33%.

A core object of this invention, then, is to provide a means for personalizing items for sale to consumers in a merchandising venue, based on their consumer profiles. Upon entry, or when in proximity to, a merchandising venue, the user's communication device signals the merchandising venue system. Consequently, a server associated with the venue detects the presence of the consumer's communication device and communicates with the consumer, providing electronic data or programming material that signals the availability of enticements such as discounts, products for sale, and merchandise- or service-related information that are correlated with the consumer profile. The electronic data or programming material is displayed on the consumer's display device. Additional electronic data or programming material may guide the consumer to the specific products or the area of the venue in which the products may be found. The consumer may also be alerted to the availability of sales personnel.

In a preferred embodiment,

(i) A consumer, or user of the system, has acquired the means to receive tailored advertising and merchandising options from a merchandising venue or commercial establishment. Methods of obtaining said means are selected from the group consisting of downloading a software application (“app”) for his or her communication device, having a preinstalled “app” on the communication device, acquiring the software from the merchandising establishment or a third-party vendor system, acquiring the apparatus—such as a smart card—from the venue or a third-party vendor, and any combination thereof.

(ii) The user of the system creates a user profile and stores it. The profile may be housed in the user's device, a server or database associated with the venue, a third party database (such as a credit card company, bank's or service provider's database), and any combination thereof.

(iii) The user of the system turns his or her communication device on and turns the application (“app”) on or sets it in the “ready” position. Alternatively, the “app” may be on whenever the communication device is on.

(iv) The user arrives at or in the vicinity of a merchandising venue or commercial establishment, and the app automatically transmits a computer-recognizable coded signal to the merchandising venue system, indicating the presence of the user, uploading the user profile or transmitting data that will enable the merchandising venue or establishment system to access the user profile, and agreeing to receive programming material.

(v) Upon recognition of the user's communication device, the merchandising venue system or the venue's online or remote service provider may transmit a personalized welcome message to the consumer, such as “Ms. Smith, welcome to ABCD Store!” The welcome message can be auditory or visual, or both.

(vi) A server processor associated with the merchandising venue system accesses the user profile.

(vii) The server processor associated with the merchandising venue system matches programming material about merchandise and/or services with the user profile.

(viii) The server processor associated with the merchandising venue system then transmits matching programming material related to at least one item of merchandise or service to the user's device for display on the user's display.

(ix) The programming material is displayed on the consumer's display in humanly recognizable form. In the case of a plurality of “matches” or “hits,” the programming material may comprise a plurality of links. The links may constitute, for example, the “top ten” (or “top five”) hits based on the consumer profile. The merchandising venue system may also transmit additional links comprising the major discounts of the day, the newest merchandise of service, the availability of a service provider (such as a favored hair colorist), and a browser window that the user may use to enter search terms of his or her own. The plurality of links may be displayed is a manner such as a list, or be tiled. The links, in effect, comprise a menu of options.

(x) Upon selecting an item of merchandise or a service of interest on his or her display means, the consumer may be presented with a second set of options, a sub-menu, whose links enable consumers to engage in activities such as learning about the “specs” of the merchandise or service, learning about available discounts, learning about the location of the merchandise or service in the venue, receiving a visual representation of what the consumer would likely look like wearing an item of clothing or what his or her living room would likely look like with an article of furniture, requesting the assistance of sales personnel, receiving more information about items of interest or purchasing items of interest, and any combination thereof. Upon selecting a merchandise or service location option, the consumer device might display location information, such as an in-store map showing the specific location of selected merchandise or services and may include a set of step by step directions that can also illuminated the path to the selected merchandise or services on the display device, or alternatively, presenting directions in the form of a venue map. The merchandising venue system can locate the consumer and track his or her progress toward the goal via means such as Wi-Fi-based positioning (WPS), WLAN positioning, Bluetooth sensors, radio frequency (RF) communication, real-time locating systems (RTLS), GPS, NFC, triangulation or trilateration of signals from the consumer's device, long-range sensor positioning, optic (e.g., infrared or visible light) and acoustic (e.g., ultrasound) indoor positioning systems, ultra-wideband (UWB) positioning, and any combination thereof. To assist consumers and promote good will, the merchandising venue system can also allow the consumer to select location information about rest rooms and assist consumers in finding them. If the consumer/consumer is wearing virtual reality (VR) glasses, the consumer can see a marked, perhaps illuminated path to the merchandise or services of interest. It is something akin to “Follow the yellow brick road” from the film The Wizard of Oz.

Another preferred embodiment applies to users who do not have a profile:

(i) The merchandise venue system or a system of a remote service provider creates and updates an electronic catalogue or compendium of available merchandise or services, newly arrived merchandise or services, and promotions, such as discounts.

(ii) The user enters the venue, or is in the vicinity of the venue, with his or her communication device and his or her “app” set in the “on” or “ready” position, indicating agreement to receiving programming material from the merchandising venue system.

(iii) The merchandising venue system detects the presence of the user communication device and establishes communication with it.

(iv) The merchandising venue system offers a generic greeting to the user, such as: “Welcome to Macy's. We're sending you a menu of today's offerings. Enjoy.” This greeting may be auditory, a text message, and the like.

(v) Following the greeting, the establishment system can transmit the menu options in the form of a plurality of links. A sample menu follows: (1) Our catalogue is a touch away, (2) Special discounts and offers, (3) What's new, (4) Build a profile with us! (5) Contact us, (6) Enter the merchandise or service that interests you in a search window (which appears on the user's display and accepts keyed-in search terms).

In a related embodiment, the consumer has enrolled in a loyalty or similar program sponsored by the merchandising venue, commercial establishment, or a third-party vendor. In this embodiment, it is also possible that the consumer will acquire apparatus that facilitates engaging in the electronic interaction with the merchandising venue system. Such apparatus may comprise a smart card, a smart phone, or any portable handheld device having a processor, communications means, and a display. The apparatus could also contain the loyalty information or else a command sequence that causes the processor of the merchandising venue merchandising or a system of a third-party service provider to access the loyalty information from the venue's database or server or the third-party database. When the consumer initiates communication with the merchandising venue system, loyalty information is uploaded to the merchandising venue system from the user's device or accessed from the venue database or server or the third-party database. The loyalty information becomes part of the user profile.

A variety of communication means can be used to transmit information between a consumer and a merchandising venue system, including but not limited to a handheld device, a mobile communication device, a smart phone, a smart card, and virtual reality (VR) glasses such as Google Glass (a wearable computer with an optical head-mounted display (OHMD). Said devices can indicate their presence in locales or venues via passive or active electronic means. For example, the device might use a short-range communication means such as Bluetooth, Wi-Fi, and any combination thereof to indicate its presence and location, and to identify the consumer. The consumer who is receptive to communications can set his or her device to access said communications. The setting of the device can also be selective; that is, the consumer may be receptive to communications from merchandising venue or commercial establishment systems but not from individuals using the system to seek a date. Or the consumer may be receptive to communications from only specific merchandising venue systems.

Two-way or three-way communication between a merchandising venue system, a consumer's device, and third party systems can be achieved via such data links as an image data link, a video data link, an audio data link, a programming data link, an online data link, a pictorial data link, an electronic data or programming material link, an electronic media link, an “information superhighway” data link, an Internet link, a computer network link, a local area network (LAN) link, a wide area network link, a wireless network link, an Ethernet network link, a Radio Frequency cellular network link, an Integrated Services Digital Network link, a telephone line link, a cable television line link, Wi-Fi, MMS, SMS, NFC, Bluetooth, e-mail, instant messaging, texting, and any combination thereof. The merchandising venue or commercial establishment system can transmit electronic data to the consumer's communication device for display in humanly recognizable form on the consumer device's display. The display may be part of the consumer communication device, associated with the consumer communication device, coupled to the consumer communication device, and any combination thereof. The display can comprise devices such as, but not limited to, a handheld device, a wireless device, a mobile communication device, an Internet-enabled telephone, a smart phone, a smart card, a computer, a tablet computer, and virtual reality glasses.

### BRIEF DESCRIPTION OF THE DRAWINGS

The above—as well as other—aspects, objects and features of the present invention are described in the Detailed Description below, which is intended to be read in conjunction with the following set of drawings. Although the illustrated embodiment is merely exemplary of systems, methods, and apparati for carrying out the invention, both the organization and method of operation of the invention, in general, together with further objectives and advantages thereof, may be more easily understood by reference to the drawings and the following description. The drawings are not intended to limit the scope of this invention, which is set forth with particularity in the claims as appended hereto or as subsequently amended, but merely to clarify and exemplify the invention.

FIG. 1 depicts an embodiment wherein the user is in reciprocal communication with a merchandising venue system while in, or in the vicinity, of a venue associated with the merchandising venue system to receive tailored programming material at the user communication device; the user having a profile stored either within his or her device or in the database associated with the merchandising venue system;

FIG. 2 depicts an embodiment wherein the electronic data or programming material is presented on the display of the user device, in this case a “smart phone”—that is, a cellular telephone that has Wi-Fi- and Bluetooth, is web-enabled, has a display, and a processor;

FIG. 3 depicts a flow chart for the creation of the user profile wherein the profile is stored in the device of the user;

FIG. 4 depicts a flowchart for the creation of the user profile wherein the profile is stored in the database associated with the merchandising venue system;

FIG. 5 depicts a flow chart for an embodiment of the invention wherein the merchandising venue system matches the available programming material with the user profile and transmits the matching programming material to the user communication device;

FIG. 6 depicts a flow chart for an embodiment of the invention wherein there is no user profile;

FIG. 7 depicts the embodiment in which menu of options are presented on the display of a user's communication device who does not have a user profile;

FIG. 8 illustrates the use of the merchandising venue system as a consumer navigates a shopping mall;

FIG. 9 depicts possible interactions between a consumer and systems of a plurality of commercial establishments, as in a shopping mall; and

FIG. 10 depicts a flow chart for the case in which a consumer is in a consumer-loyalty program.

### DETAILED DESCRIPTION OF THE PREFERRED EMBODIMENTS

The invention may be understood more readily by reference to the following detailed description of a preferred embodiment of the invention. However, techniques, systems, and operating structures in accordance with the invention may be embodied in a wide variety of forms and modes, some of which may be quite different from those in the disclosed embodiment.

Consequently, the specific structural and functional details disclosed herein are merely representative, yet in that regard, they are deemed to afford the best embodiment for purposes of disclosure and to provide a basis for the claims herein, which define the scope of the invention. It must be noted that, as used in the specification and the appended claims, the singular forms “a”, “an”, and “the” include plural referents unless the context clearly indicates otherwise.

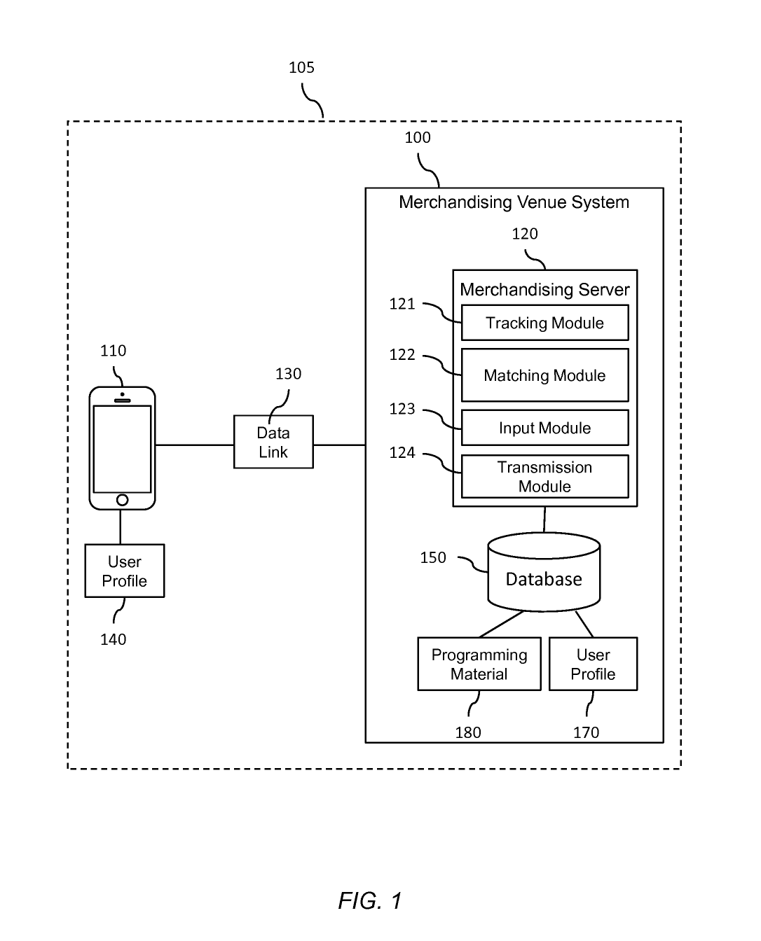

Reference is now made to FIG. 1, which depicts an embodiment of the invention comprising a user (the consumer) communications device 110 and a merchandising venue system 100. In a preferred embodiment, the merchandising venue system 100 is associated with a venue 105 to communicate with a communication device 110 located within venue 105 or in the vicinity of venue 105. The merchandising venue system 100 generally comprises a merchandising server 120 and a database 150. The database 150 can be co-located with the merchandising server 120, or it can be located remotely in various different systems and locations. The relationship may involve remote merchandising server 120 and database 150 or the merchandising server 120 and/or database 150 can be housed within the merchandising venue 105. In addition, the merchandising server 120 could be completely integrated with the database 150.

The user communication device 110 may be any communication device known in the art, or later discovered, including, but not limited to a hand-held communication device, a wireless communication device, a smart phone, a cellular telephone, a camera-enabled cellular telephone, virtual reality (VR) glasses (that is, a wearable computer with an optical head-mounted display (OHMD)), a personal digital assistant (PDA), an Internet-enabled telephone, a personal digital assistant, an Internet-enabled device, an intelligent terminal, a smart card, a personal computer, a tablet computer, a mini-tablet computer, a laptop computer, and a device having a processor. In a preferred embodiment, user communication device 110 comprises a display, a processor, a memory, and a user interface (e.g., a touch screen, keyboard, mouse, voice recognition, or the like). The user carrying the communication device 110 enters the merchandising venue 105, or arrives in its vicinity. The user communication device 110 has software that causes it to transmit messages via data links 130 to the merchandising venue system 100 associated with the merchandising venue. The user device 110 transmits the identity of the user and agreement to receive programming material about products and/or services available in the venue 105. The merchandising venue system 100 will transmit “personalized” or tailored programming material, based on the merchandise and services that are available, as stored in the database 150 for creating, storing, and updating programming material 180 related to products and services and the user profile.

Merchandising server 120 may be incorporated into a conventional standalone server, although in other embodiments, the function of the merchandising server 120 may be distributed across multiple computing systems and architectures. For example, system 100 may include a separate web, app, or email server as an interface between the merchandising server 120 and user communication device 110. The merchandising server 120 is preferably a network server utilizing processing modules for processing information received to provide tailored programming material to user communication device 110. The merchandising server 120 and/or other system servers may include at least one controller or processing module (CPU or processor), at least one communications module port or hub, at least one random access memory module and one or more data storage modules. All of these latter elements are in communication with at least one processing module to facilitate the operation of the system 100 of the present invention.

Database 150 stores programming material 180 related to products and services. A user-created user profile 140 can be stored on the user device or in the database 170. Database 150 can also record the user's shopping and purchasing behavior and store it in user profile 170, enabling further tailoring of the programming material 180. That is, a user could actually have two user profiles, both of which can contribute to the personalizing or tailoring of programming material: a user-created profile that is stored on the user's communication device 140, and a venue-created shopping and purchasing profile 170 that is stored in the database 150. It is also possible that both kinds of user profiles would be housed on the database 150 and function as a single user profile, one part of which is updated by the user's shopping and purchasing behavior.

It should be understood that the merchandising server 120 and/or database 150 harboring the user profile 170 may be a single unit, a plurality of servers/databases, or a third-party servers database that may be accessible by a plurality of merchandising venues. Examples of useful third-party servers/databases include a credit card company server/database that represents and processes the card used by the user/consumer, server/database of bank used by the user/consumer, or a server/database operated by a third-party service provider that oversees the functioning of the system at various merchandising venues, it would clearly be desirable for the system 100 to be useable at a plurality of venues and for the user information to be accessible by each of these venues. It is limiting for a consumer to have to use a different credit card with every merchant and vendor. Similarly, it would be disadvantageous for a consumer to need to separately store a user profile with every merchandising venue. Therefore, it would be advantageous for the user to store the profile in his or her device 110, or in a database that is linked to the merchandising system associated with a plurality of venues.

Merchandising server 120, database 150, and communication device 110 may include any one of numerous forms of storage devices and storage media, such as solid-state memory (RAM, ROM, PROM, and the like), magnetic memory, such as disc drives, tape storage, and the like, and/or optical memory, such as DVD.

Data links 130 can be used to transmit the matched programming material, or other information, between the user's device 110 and merchandising system 100, or between system components. The data link 130 may be any data link known in the art or later discovered, including, but not limited to an image data link, a video data link, an audio data link, a programming data link, an online data link, a pictorial data link, an electronic data link, an electronic media link, the Internet, a computer network, a local area network, a wireless local area network, a Wi-Fi network, a wide area network, a wireless network, an Ethernet network, a Radio Frequency cellular network, Bluetooth, an Integrated Services Digital Network, a telephone line, and a cable television line.

Merchandising server 120 may further comprise a plurality of modules for enabling the delivery of programming material to user communication device 110. For example, the merchandising server 120 may include a tracking module 121, a matching module 122, an input module 123, and a transmission module 124.

The tracking module 121 enables the system 100 to respect the privacy of the user. The merchandising system 100 makes contact with the user (consumer) communication device 110 only after the user enters a venue 105 (e.g., a brick and mortar retail location) or its immediate proximity. After the entry, device 110 enabled by the user establishes communication with the merchandising system 100 associated with the venue 105. Tracking module 121 tracks the location of the consumer device 110, but does so only when the consumer requests help in finding merchandise or services within the venue 105. Location tracking means are well known (e.g., Bonner et al., U.S. Pat. No. 7,734,513 and U.S. Patent application publication No. 20120245974 A1; Blackhurst et al., International publication No. WO 2012166481 A1; Elliott, U.S. Pat. No. 8,412,590; Yu, 2012; Henn, 2012) and therefore need not be detailed here. User/consumer device location tracking of progress toward the goal of finding the desired merchandise or service can be accomplished electronically by means such as Wi-Fi-based positioning (WPS), WLAN positioning, Bluetooth sensors, radio frequency (RF) communication, real-time locating systems (RTLS), GPS, NFC, triangulation or trilateration of signals from the consumer's device, long-range sensor positioning, optic (e.g., infrared or visible light) and acoustic (e.g., ultrasound) indoor positioning systems, and ultra-wideband (UWB) positioning.

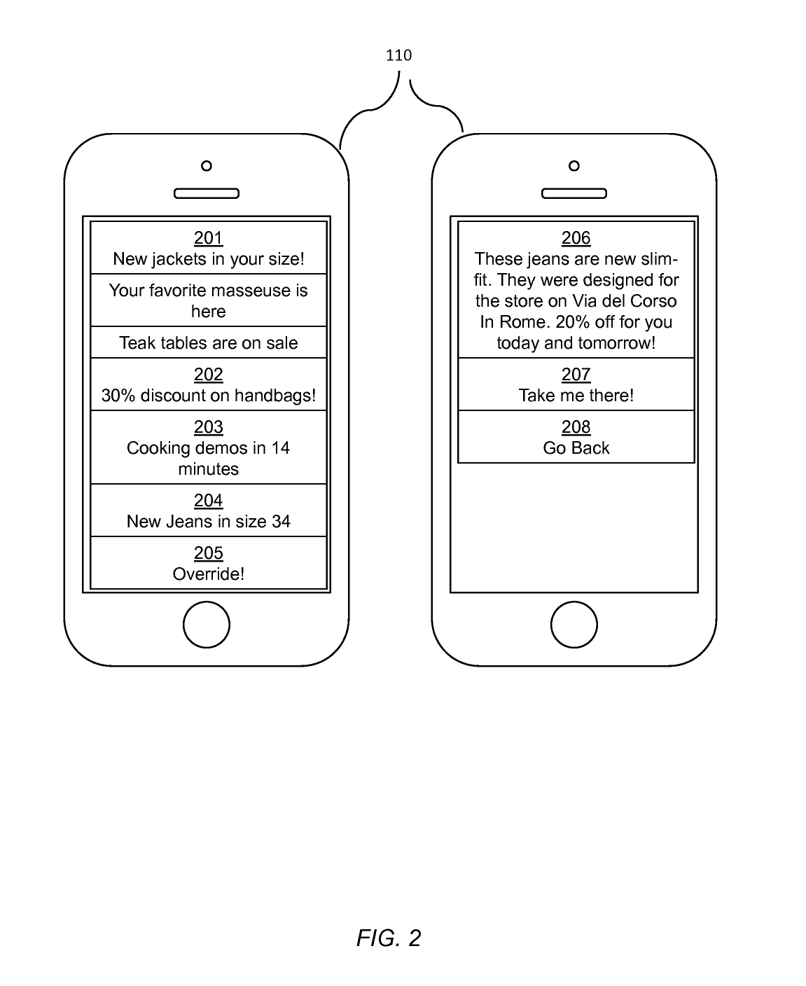

The matching module 122 matches the available programming material 180 with the user profile (140 or 170). The transmission module 124 transmits the matched programming material to the user device 110. The programming material is then displayed on the user device's 110 display. When more than one product or service is transmitted, it can be presented as a menu, which comprises a plurality of links, on the user's device 110. The input module 123 enables the user to interact with the merchandising venue system 100 to select articles of merchandise or services and retrieve more information about them, such as advertising, information about the availability of merchandise or services, the location of the merchandise or service in the merchandising venue, additional information about the merchandise or service, information about related merchandise or services, information about discounts and promotions, information about the delivery of merchandise, information about the merchandising venue, and contact information, as we see in FIG. 2.

Reference is now made to FIG. 2, which shows sample embodiments of screen content for users in a merchandising venue, in this case a department store. Displayed is the availability of merchandise, which, according to the user profile, is in the size of the user at 201. Displayed is also an example of a promotion on handbags at 202. The user's profile shows that she is very interested in cooking; therefore, an announcement of an available service of interest is displayed at 203. Note also that the merchandising venue system announces that the user's favorite masseuse is present. This announcement is made possible by the venue's tracking of the user's purchasing behavior at the venue and user-feedback about venue staff. The user has also entered her children's sizes in her profile, so the system is capable of informing her of the arrival of blue jeans in her son's size 204. If the user wished to enter a product or service of her own, “on the fly,” she could select the “Override!” option 205 and then key in her desire. There can also be a menu item that says “More options” or the like, which could include options such as “Buy now,” “Make an appointment,” “Send me a sales assistant,” and the like. Alternatively, the override function may be accomplished by means of entering one or more key terms in a window on the device screen.

In this case, the user selected “New jeans in size 34” option 204 and then the sub-menus with items 206, 207, and 208 appeared. In the example, the sub-menu lines comprise more information about the jeans, including the availability of the 25% time-sensitive discount. If the user selects “Take me there!” 207, the route to the jeans will be highlighted on a store map that will appear on her screen. Upon selecting a location option, the consumer device might display location information, such as the in-store map with accompanied by step by step directions. As described, the merchandising venue system can locate the consumer and track his or her progress toward the goal via means such as Wi-Fi-based positioning (WPS), WLAN positioning, Bluetooth sensors, radio frequency (RF) communication, real-time locating systems (RTLS), GPS, NFC, triangulation or trilateration of signals from the consumer's device, long-range sensor positioning, optic (e.g., infrared or visible light) and acoustic (e.g., ultrasound) indoor positioning systems, ultra-wideband (UWB) positioning, and any combination thereof. A user wearing virtual reality (VR) glasses might also see a marked, perhaps illuminated path to the desired merchandise or service.

FIG. 2, as noted, depicts an embodiment wherein the electronic data or programming material is presented on the display of the user's “smart phone”—that is, a cellular telephone that is Wi-Fi- and web-enabled, has a display means, and a processor. The software that enables the device's interaction with the merchandising venue system 100 can have been pre-installed on the device, installed by the phone service provider, downloaded from a service-providing or merchant's web-site, downloaded from an App Store, and the like. The device 110 is referred to as a communication device, but, like other smart phones, it is akin to an electronic “Swiss Army Knife,” meaning that it houses a plurality of functions, from phone calling, emailing, and texting to surfing the web, and enacting any number of “apps.” The device 110 handles short-range communications via Wi-Fi, Bluetooth, and the like, as well as longer-range communications. It may conveniently communicate with the merchandising venue system 100 via Wi-Fi and/or Bluetooth, which is why the device can be set to automatically interact with the merchandising venue system 100 when it is within or in the proximity of the venue 105. Although FIG. 2 depicts a smart phone, many other devices can be enabled to communicate with the venue. For example, the venue or a third party could distribute “smart cards” which are “chipped,” and have transceivers and displays. These cards may comprise a kind of loyalty card in addition to the communications and display functions.

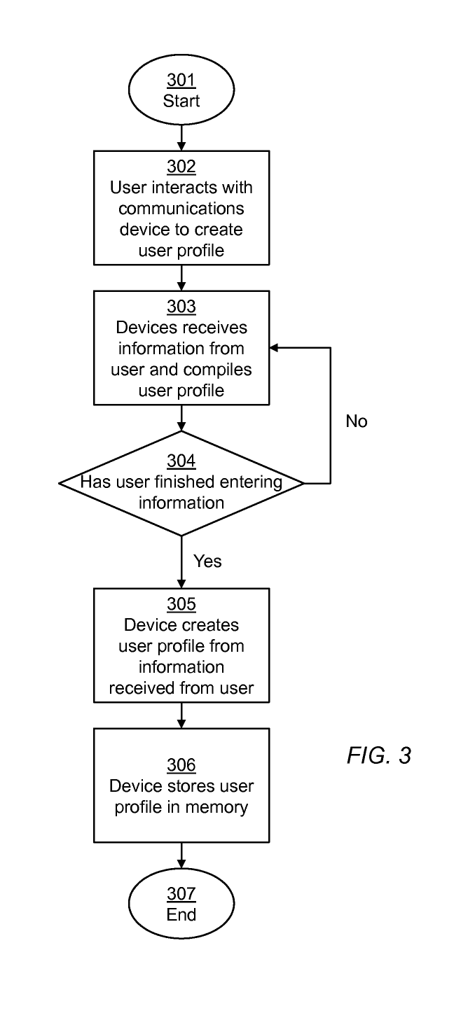

As shown in FIG. 3, the method of creating a user profile according to an embodiment for storage in the memory of user communication device 110 starts at step 301. At step 302, the user chooses to create a user profile on the device. In step 303, the user interacts with the device so that the device may receive certain information from the user. The user selectively chooses certain preferences for retrieval of particular types of electronic data. For example, a user interested in buying clothing for his or her family might specify the types of clothing the family prefers and enter the genders and sizes of family members. Technologies exist whereby a user can enter photographs of individuals and then see how that individual might look in certain apparel (e.g., Lawrence et al., U.S. Patent application publication No. 20110022965). In this case, the processor associated with the merchandising venue server would be able to access the photo of the family member, access visual representations of the merchandise, and combine the two so that the consumer/user could “see” the apparel “on” the family member.

In step 304, the device determines if the user has finished entering information. If the user has finished, the device creates a user profile in step 305. In step 306, the device stores the user profile in memory. The preferences may be stored in a user device such as a cell phone or smart phone having a memory means.

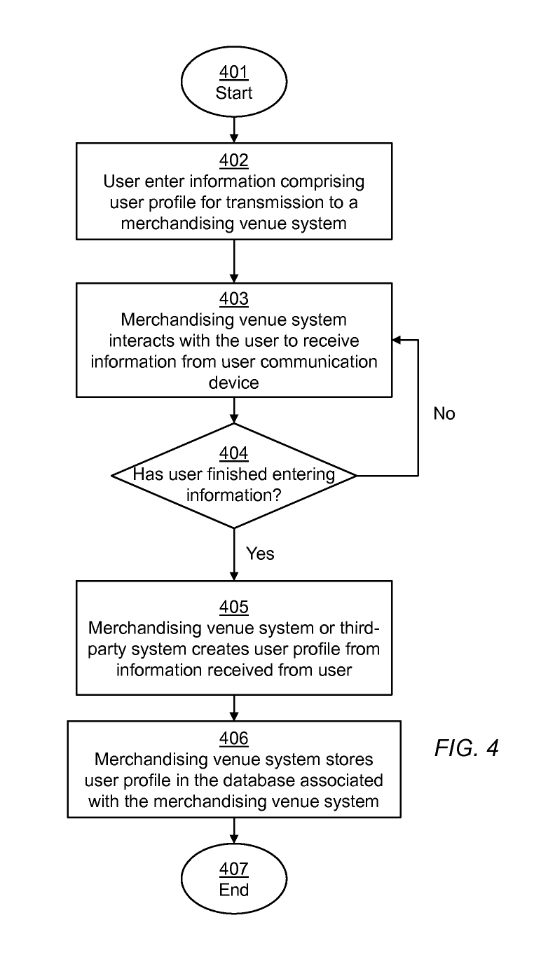

FIG. 4 depicts an embodiment related to FIG. 3. Here, however, the user chooses to store his or her profile on a database 150 associated with the merchandising venue system 100, as shown in step 402. In step 403 the merchandising venue system 100 rather than the user's device 110 interacts with the user to receive information from the user. In step 404, the merchandising venue system 100 determines if the user has finished entering information. If the user has finished, the merchandising venue system 100 creates a user profile in step 405. In step 406, the merchandising venue system 100 stores the user profile in the database 150.

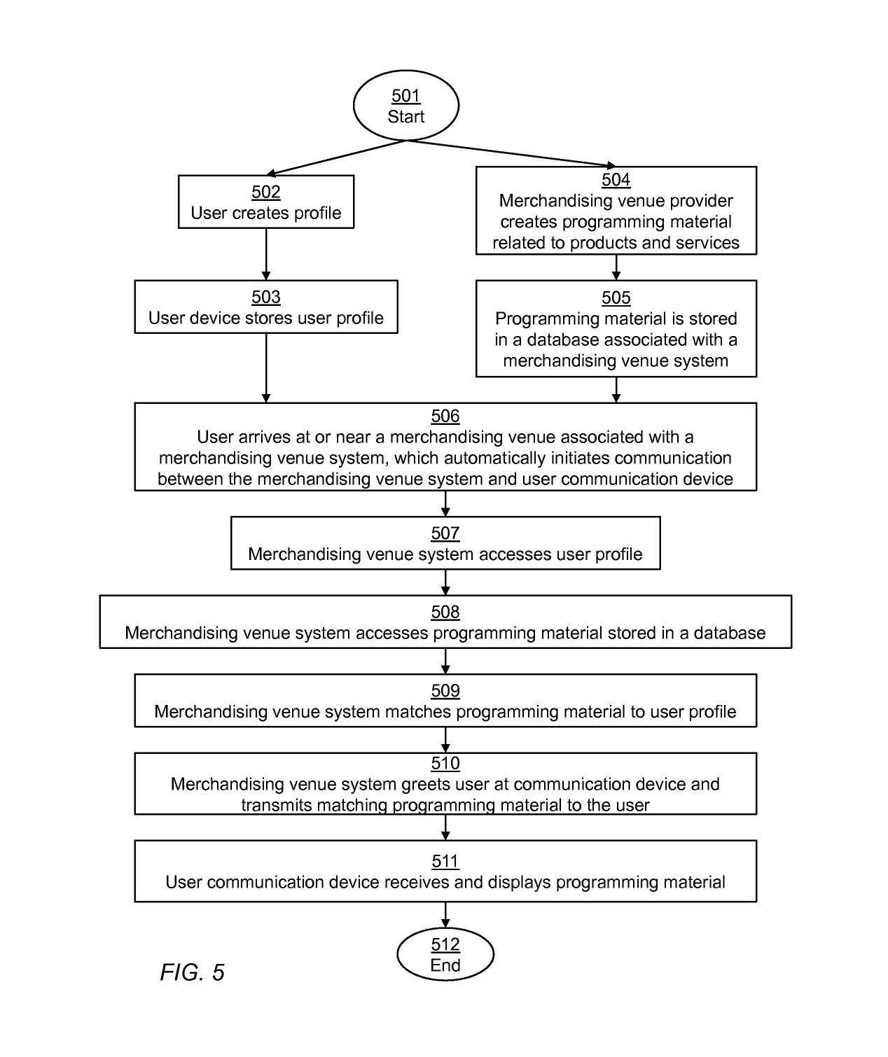

Referring to FIG. 5, which depicts a flow chart that details the steps used by the consumer/user communication device 110 and the merchandising venue system 100 in a preferred embodiment of the present invention. In step 502 the user/consumer creates a user profile, and in step 503 he or she stores the user profile, either in the user's device 110 or in a database 150 associated with the merchandising venue system 100. The merchandising venue system 100, server 120 and/or database 150 might either “belong” to the merchandising venue or to a third-party, such as a credit card company, a bank, or the service provider for the system disclosed in the present invention. The merchandising venue service provider creates, or arranges for a third party to create, the programming material 180 related to the products and services the venue offers at step 504. The programming material is stored in a database 150 associated with the merchandising venue system 100 at step 505, which may be the merchandising venue's own database or “powered” by a third-party service provider. The user carrying a communication device arrives within or within the vicinity of the merchandising venue at step 506. The software on the communication device 110 that will initiate communication with the merchandising venue system 100 is either “on” whenever the user device 110 is on, or the user switches it on in anticipation of arriving at the venue or in anticipation of using it at the venue. Using the software, the user device—and presumably the user—“announces” its presence at the merchandising venue to the merchandising venue system 100 and, by doing so, indicates the agreement of the user to receive programming material from the merchandising venue system 100 at step 506.

Still referring to FIG. 5, the merchandising venue system 100 now engages in a series of steps. First, since the user has identified himself or herself to the merchandising venue system 100, it would be advantageous for the merchandising venue system 100 to offer a personalized greeting, such as “Hello, Mr. Gates. Thank you for shopping at Great Buy today.” If the user has earphones or headphones, he or she may hear the greeting. Otherwise, it may appear as text on the user communication device 110 display. Following the greeting, there may be an intermittent step in which the merchandising venue system 100 announces something like “Here is what we have for you right now!” In step 507, then, the merchandising venue system 100 accesses the user profile, either from the user's device or from the database in which the profile has been stored. In step 508 the merchandising venue system 100 connects with, or accesses, the programming material 180 stored in the database 150. In step 509, the processing means associated with the merchandising venue system 100 matches the programming material to the user profile, thus tailoring or narrowing the amount of material that will be transmitted to the user. In step 510 the merchandising venue system 100 transmits that matching programming material to the user communication device 110. In step 511, the user communication device 110 receives the material and displays it on the display to the user.

Referring back to FIG. 2, the programming materials can be presented as a menu consisting of a plurality of links. The left part of FIG. 2 shows the example of the top six “hits.” Selecting any one of them will result in the user device's reception of additional information about the merchandise or service. The right part of FIG. 2 shows an example of additional information 206, the opportunity for the user to request that the merchandising venue system 100 send location information about the product or service and track the user's progress in arriving at the location of the product or service 207. Finally, the user can elect to return to the previous menu 208.

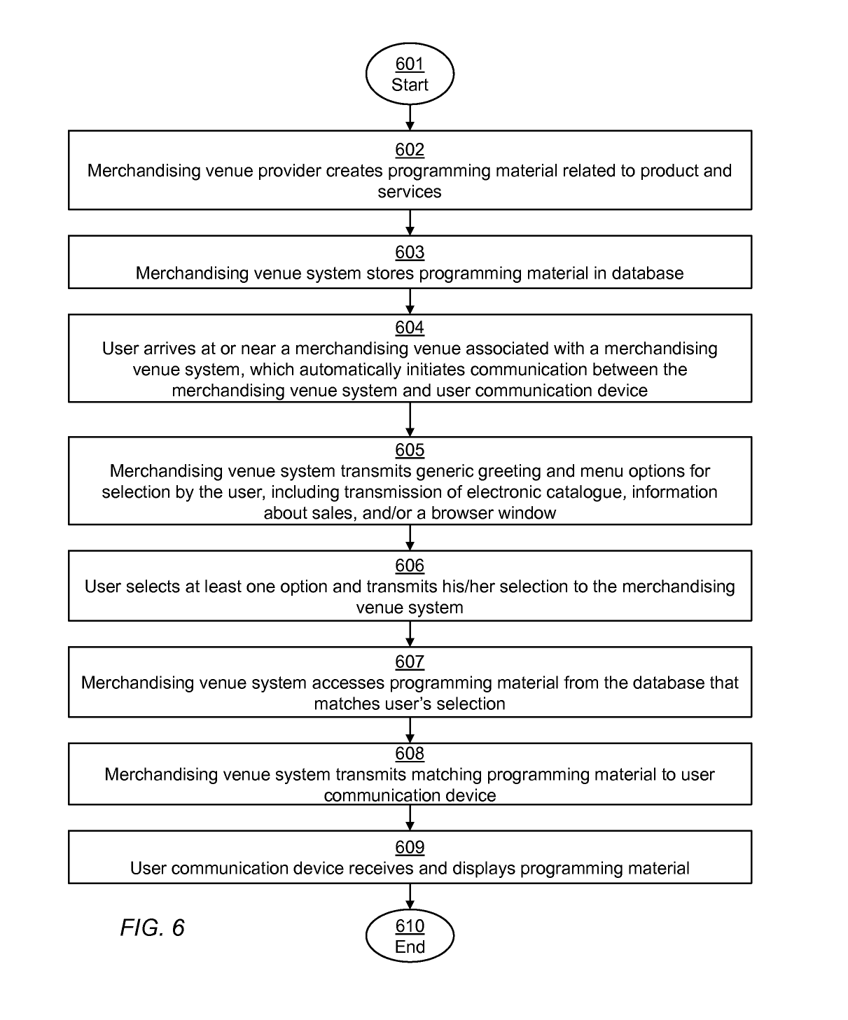

Now referring to FIG. 6, there is shown a flow chart depicting an embodiment of the present invention in which there is no user profile. It is possible that the user chose not to create and store a profile because of concerns about privacy. He or she may not have had the time to create a profile. He or she might not have known that creating a user profile was an option. Regardless of the reasons for the lack of a user profile, in step 602 the merchandising venue service provider creates programming material relating to the categories of merchandise and services it offers. The result is in effect the creation of an electronic catalog of what is available. The programming material is stored in a database associated with a merchandising venue system 100. The programming material is updated regularly as merchandise arrives and is sold or returned, as prices change, as service providers come and go. The venue service provider also creates an initial menu of options to present to consumers, to initiate the interactive experience. The merchandising venue system 100 stores the catalogue material and the list of options in a database 603. The merchandising venue system 100, server 120, and/or database 150 may belong to the venue service provider. They may be housed within the venue. They may belong to a third-party service provider. Regardless of who owns the merchandising venue system 100, server 120 and/or database 150, they may be physically housed remotely.

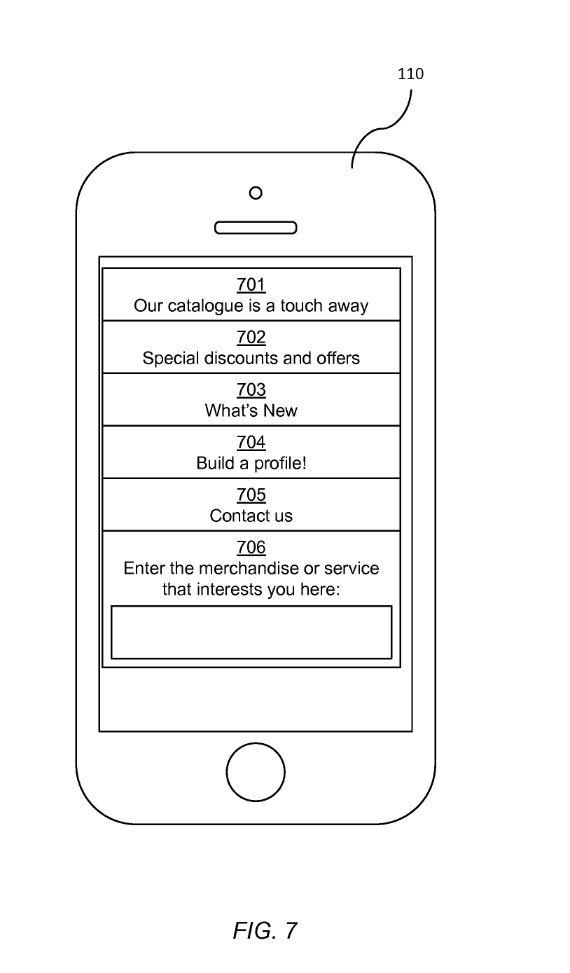

Still referring to FIG. 6, in step 604 the user carrying a communication device 110 arrives at or in the vicinity of the venue 150. Still on step 604, the user communication device 110 will need to have software that indicates that a customer has arrived and agrees to receive programming material related to merchandise and services in order to initiate communication with the merchandising venue system 100. Because the merchandising venue system 100 cannot identify the communication device 110 and has no profile of the consumer/user, in step 605 the merchandising venue system 100 displays a “default” condition, for example as shown in FIG. 7.

Referring now to FIG. 7, the communication device 110 displays a variety of possible menu options, which would be presented as a plurality of links following the greeting. The blank browser window enables the user to search for a specific kind of product or service 706. For example, a user may enter an item such as “Tumi luggage” or “iPhone 27-S” in the browser window. But let it also be noted that the user can enter “I need a rest room” (or “toilet” or “bathroom”) now,” and the program will seize upon the key term and its variants to provide directions to the nearest bathroom. The program will also offer to escort the user there by location and tracking means. If the customer keys in “Food” or “I′m hungry” or “famished,” the program will again seize on key terms, provide information about a restaurant or snack bar in or near the venue, and again offer location information and directions.

Still referring to FIG. 7, as further examples: If the user elects to see the catalogue 701, the merchandising venue system 100 can transmit a plurality of links representing the most commonly sought categories of items to the user communication device, perhaps the “top ten.” At the bottom of the list will be a term such as “More,” which, upon being selected, would instruct the merchandising venue system 100 to transmit its second list of categories, and so on. At any time, the user could also select a link with a term such as “Override!” meaning that the user would like to receive an empty browser window into which he or she can enter his or her own search term.

Referring again to FIG. 7, if the customer selects “Build a profile!” at 704, he or she might receive a first message explaining that a profile will help the establishment (and, perhaps, other establishments) to automatically provide personalized information upon entry, such as merchandise in an area of interest, and discounts on preferred merchandise or services. The Build-a-Profile option program might then simply request gender and age to begin the process, and allow the consumer to continue answering queries now or later, if more convenient.

“Special discounts and offers” option 702 will cut across categories and alert the user to the best bargains of the day, not necessarily bargains that would have been consistent with a user profile. “What's new” option 703 could refer to almost anything—new merchandise, a new store, construction work, and so forth. “Contact us” option 705 can provide a phone number, and email address, a chat—another plurality of links from which the user can make a selection.

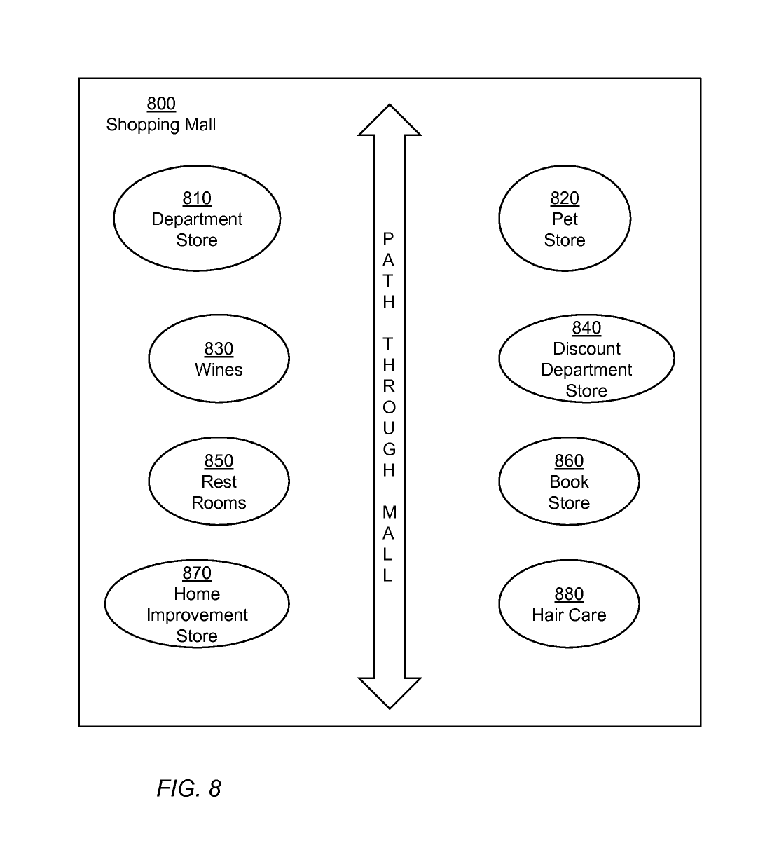

We now refer to FIG. 8, which shows a consumer/user carrying a communication device 110 in a shopping mall 800—that is, among a plurality of commercial establishments. Just as a single merchandising venue or commercial establishment can interact with the user, so too can a plurality of venues in a mall or other group of commercial establishments. This particular embodiment obtains when the consumer is in the “public space” of the mall 800. Examples of public space include the walkways, stairs, elevators, parking lot or area, and rest rooms. To reach consumers in these spaces, the individual establishments can either share the merchandising venue system 100, which could result in the user receiving an orderly sequence of information from a plurality of establishments. If the establishments do not share the system 100, the user could interact, upon close proximity or entry into those that do have the system. If the establishments share the system 100, information from a plurality of establishments could appear on the user's device as a plurality of links, or, as mentioned, the establishments could “take turns.” A processing means associated with the merchandising venue system 100 of the mall could determine the sequencing and placement of the links. The initial greeting could refer to the mall as a whole rather than a single establishment. However, once the consumer has entered the space of an individual commercial establishment, the interactions would be based on the merchandise and/or services of that establishment.

Let us consider a user of the system who has stored a user profile and is in public space. Still referring to FIG. 8, the user—whose profile indicates that the user prefers Australian white wines—may receive notice from the wine store 830 that an Australian Sauvignon Blanc wine has just arrived. When the user touches the link, a sub-menu can appear, offering, as an example, “Description and ratings” of the Sauvignon Blanc wine, “Promotions and discounts,” “Store location” (upon touching this link, the user can request directions to the store), “Put merchandise on hold” (a sub-menu will allow the user to specify how many bottles and for what duration of time), “Charge to my account,” “Ship to me,” and “Contact Us.” By selecting “Contact Us,” the user can be directly calling the individual who is knowledgeable about the Sauvignon Blanc wine, the discount, and the like. The user's profile also shows that he is a “Do-It-Yourself” person. Home Improvement Store 870 might inform him of promotions on tools.

Part of this user's profile comprises his purchasing history at the mall. Therefore, the Hair Care 880 establishment might inform him that his favorite hair stylist, John, has returned from abroad. By selecting the Hair Care link that advertises John's presence, the user can further select something like “Book It,” and the next sub-menu might show a plurality of times that John is available. The Pet Store 820 might notify the user, who is also a tropical fish enthusiast, that Discus Fish have just arrived from Africa. By selecting the link, the user might find out that the Discus fish are $17.99 each, are about 1-year old, are 3 inches in diameter, gold bodied with bluish fins, and that, as with the wine store, the user can put a hold on them.

While rest rooms 850 would not send advertisements, if the user were to key rest rooms into the browser window, he would learn of their location and could ask the location means to assist him in finding the rest rooms. In an alternative embodiment, the Shopping Mall owner 800 may operate the merchandising venue system 100 and offer information and advertising to the user.

The following describes how a user without a user profile might use his device to negotiate the mall. This user communication device 100 will also have software that initiates interaction with the merchandising system 100 of the mall in order to obtain useful programming material. However, the programming material he or she receives will be generic, until the user begins to make selections from pluralities of links, thereby obtaining sub-menus. More specifically, upon entry to the mall, and perhaps within the vicinity of the mall, the user's communication device 110 automatically indicates that a user of the system 100 is present and indicates agreement to receive programming material.

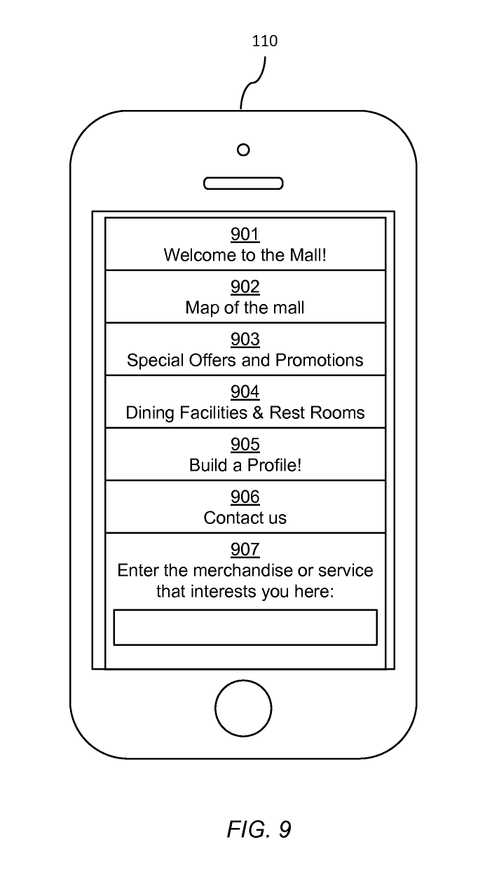

The user enters and receives a plurality of pieces of information, most of which comprise links on his or her communication device. Referring to FIG. 9, these items, for example, might begin with “Welcome to the Mall! We have a number of sales and events that may be of interest. Enjoy your visit!” as shown on the communication device 110 display at 901. Link 902, when touched, might download a map of the mall to the user's device. Link 903 might lead to a list of special discounts and promotions in the mall. Malls would arrange the ways in which these discounts and promotions would be listed. Individual commercial establishments might pay for the upkeep of the system through this advertising, and perhaps the highest bidder would have the most “screen time.” Or the offers and promotions might simply rotate, such that one establishment's specials occupied, say, two minutes, and then another establishment's were listed. Or all specials and offers might “move” and repeat, as does the “crawl” along the bottom of the screen of a television set. Link 904 would take users to a list of the dining and rest room facilities at the mall. Users could touch a link to a restaurant to download a menu and book a table. Touching a sub-menu link titled “Find rest rooms” or the like could download another map of the mall, showing the nearest rest rooms and offering to “escort” the user there via location positioning technology. Link 905 would encourage the user to take the first steps in building a profile, perhaps by entering age and gender and then completing the remainder of the profile at his or her leisure. The profile could be stored in the user's device, in the mall's database, in a third party's database, or in a network of databases. Ideally, the user would create the profile once, and then it would be available to any merchandising venue—any store, any commercial establishment.

Still referring to FIG. 9, “Contact us” link 906 could connect to (1) a human at the mall, (2) the mall artificial intelligence, or (3) a broader service provider, whose physical presence might be anywhere. Once linking on the “Contact us” link, the user could text, send an email, set up a chat, make a phone call, and the like. A browser search window 907 would also be provided to enable the user to locate merchandise, a store, emergency facilities, and the like.

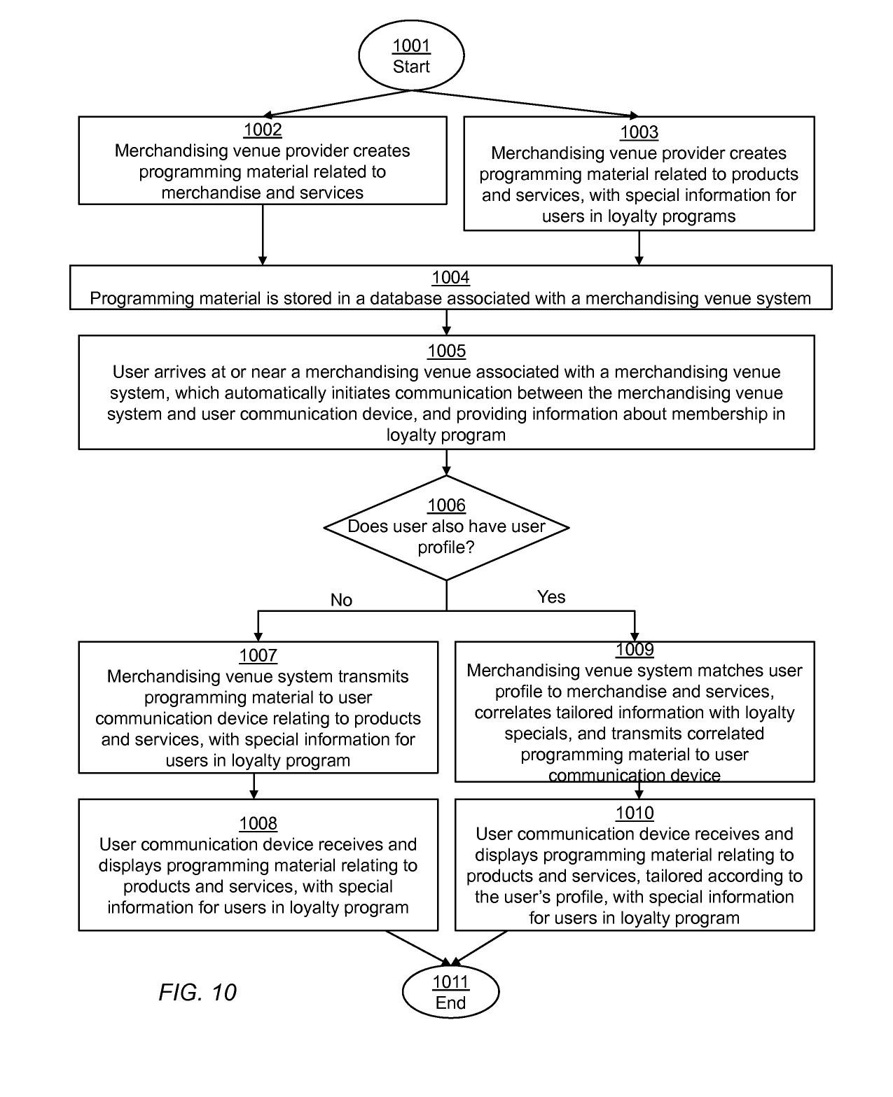

Referring now to FIG. 10, which shows an embodiment in which the user of the system—the consumer—is a member of a venue's loyalty program. It can be the case that enrolling in the loyalty program indicates agreement on the part of the consumer for the merchandising venue to transmit programming material to the user's communication device when the user is at, or in the vicinity of, the venue. Membership in the loyalty program can also mean that the user agrees to receive transmissions from the merchandising venue in other locations and on other apparatus; but we are concerned here with the experience at or proximate to the venue itself.

In the embodiment shown in FIG. 10, the merchandising venue provider or commercial establishment provider creates two versions of its programming material relating to products and services: one for consumers who are not members of the venue's loyalty program 1002, and the other for consumers who are members of the loyalty program 1003. The special information for members of the loyalty program will include, but not be limited to, information about special newly arrived merchandise being held for “loyal” consumers only for a certain amount of time, discounts above those given to consumers who do not belong to the program, and the like. Both versions of the programming material are stored in the merchandising system's database 1004, which, as in other cases, may be housed at the venue or housed remotely.

Still referring to FIG. 10, a user of the system—a consumer—who is a member of the venue's loyalty program arrives at the venue carrying the communication device and provides information about his or her membership in the loyalty program 1005. The loyalty information may be stored in the user's device, in a database 150 associated with the merchandising server 120 housed in the merchandising venue, or in a remote database. However, the user's arrival at the venue either causes the loyalty information to be uploaded to the database 150 through the merchandising server 120 from the consumer's device, or to be accessed from a local database by the merchandising server or from the remote database. Transmission of loyalty information from the user's device can work in at least two ways: it can be automatically uploaded to the database upon the user's arrival, or upon obtaining information that the user has arrived, the merchandising server of the venue can access the loyalty information. For users who have user profiles, the loyalty information may be stored as part of the user profile and uploaded or accessed at the same time and in the same way. But it is also possible that the loyalty information and the user profile will be stored as distinct files or housed in different places.

Referring further to FIG. 10, once the user arrives at the venue, the processing means associated with the merchandising venue system 100 searches for a user profile 1006. If there is no user profile but the user is a member of the loyalty program, the merchandising venue system 100 will transmit programming material having the special information for users in the loyalty program to the user's communication device 1007. The user's communication device then receives and displays the programming material 1008. If the “loyal” user does have a profile, then the processing means of the merchandising venue system 100 will match the programming material to the user profile and transmit the correlated programming material to the user's communication device, along with the special loyalty information related to that programming material 1009. The tailored programming material and its associated special loyalty information will be received and displayed by the user's communication device 1010.

Although the invention has been described above with reference to several presently preferred embodiments, such embodiments are merely exemplary and are not intended to define the scope of, or exhaustively enumerate the features of, the present invention. Accordingly, the scope of the invention shall be defined by the following claims. Where a feature or limitation of a preferred embodiment is omitted in a claim, it is the inventors' intent that such claim not be construed to impliedly require the omitted feature or limitation.

What is claimed is:

1. A method for displaying programming material to a user, comprising the steps of:
storing a user profile comprising at least one user preference in a user communication device or in a database associated with a merchandising server;
detecting the user communication device upon the communication device's arrival at, or in the vicinity of, a merchandising venue or commercial establishment associated with the merchandising server;
receiving from the user communication device an indication that the user has granted permission to access the user profile and transmit communications to the user communication device;
initiating communication between the user communication device and the merchandising server;
accessing programming material stored in the database;
accessing the user profile by the merchandising server;
matching by the merchandising server the at least one user preference with the programming material;
transmitting from the database to the user communication device the programming material that was matched with the at least one user preference for receipt by and display on the user communication device.

2. The method of claim 1 wherein the user profile comprises a plurality of user preferences.

3. The method of claim 1 wherein the user interacts with the user communication device in creating the user profile.

4. The method of claim 1 wherein the user provides user-specific information to the user communication device in creating the user profile.

5. The method of claim 1 wherein the user provides answers to a plurality of predetermined questions provided by the merchandising server in creating the user profile.

6. The method of claim 1 wherein the user communication device is selected from the group consisting of a hand-held communication device, a wireless communication device, a smart phone, a cellular telephone, a camera-enabled cellular telephone, virtual reality (VR) glasses, a wearable computer with an optical head-mounted display (OHMD), a personal digital assistant (PDA), an Internet-enabled telephone, a personal digital assistant, an Internet-enabled device, an intelligent terminal, a smart card, a personal computer, a tablet computer, a mini-tablet computer, a laptop computer, a device having a processor, and a device having any combination thereof.

7. The method of claim 1 wherein communication between the user communication device and the merchandising server is established via at least one data link that is recognized by the user communication device and the merchandising server.

8. The method of claim 1 wherein communication between the user communication device, the merchandising server, and the database is established via at least one data link that is recognized by the user communication device, the merchandising server, and said database, and any combination thereof.

9. The method of claim 7 wherein the data link is selected from the group consisting of an image data link, a video data link, an audio data link, a programming data link, an online data link, a pictorial data link, an electronic data link, an electronic media link, the Internet, a computer network, a local area network, a wireless local area network, a Wi-Fi network, a wide area network, a wireless network, an Ethernet network, a Radio Frequency cellular network, Bluetooth, an Integrated Services Digital Network, a telephone line, a cable television line, and any combinations thereof.

10. The method of claim 1 wherein the database is selected from the group consisting of a local database, an in-venue database, a remote database, a remote server, a network of databases, and any combination thereof.

11. The method of claim 1 wherein the user communication device comprises a display coupled to the user communication device, is part of the user communication device, or any combination thereof.

12. The method of claim 1 wherein the user communication device has a processor.

13. The method of claim 1 wherein the merchandising venue or commercial establishment is selected from the group consisting of a store, a retail store, a department store, a grocery store, a supermarket, an electronics store, an office supplies store, a convenience store, a bookstore, a wholesale distributor, a retail distributor, a theater, a stadium, a restaurant, a shopping mall, a museum, a gallery, a restaurant, a town or village commercial district, a street with a plurality of merchandising venues, and any combination thereof.

14. The method of claim 1 wherein the programming material transmitted from the merchandising server is related to a plurality of articles of merchandise and/or services.

15. The method of claim 14 wherein said plurality of articles of merchandise and/or services is displayed as a menu on a display device associated with the user communication device, and further wherein the user can select at least one option to receive additional programming material.

16. The method of claim 15 wherein upon selection of an article of merchandise or a service, the user receives a sub-menu on a display device associated with the user communication device, said sub-menu having a plurality of options selected from the group consisting of: availability of merchandise or services; location of the merchandise or service in the merchandising venue; additional information about the merchandise or service; promotions and discounts associated with the merchandise and/or services, or with related merchandise and/or services; opportunity to purchase the merchandise and/or services; opportunity to have merchandise shipped to a location of the user's choosing, and any combinations thereof.

17. The method of claim 15 wherein the user selects location of the merchandise or service, and is further presented with the option of having the merchandising server track his or her location in the venue and provide instructions for arriving at the location of the merchandise or service.

18. The method of claim 17 wherein said tracking is accomplished by means selected from the group consisting of Wi-Fi-based positioning (WPS), WLAN positioning, Bluetooth sensors, radio frequency (RF) communication, real-time locating systems (RTLS), GPS, NFC, triangulation or trilateration of signals from the consumer's device, long-range sensor positioning, optic, infrared or visible light, and acoustic, ultrasound, indoor positioning systems, ultra-wideband (UWB) positioning, and any combination thereof.

19. The method of claim 17 wherein said instructions are selected from a group consisting of audio instructions, continual audio instructions, a venue map with a highlighted route, a venue map with a continually updating highlighted route, a virtual display showing the updating highlighted route as from the vantage point of at least one eye of the user, and any combination thereof.

20. The method of claim 1 wherein said programming material is selected from a group consisting of advertising, information about the availability of merchandise or services, the location of the merchandise or service in the merchandising venue, pricing or additional information about the merchandise or service, information about related merchandise or services, information about discounts and promotions, information about the delivery of merchandise, information about the merchandising venue, contact information, and any combination thereof.

21. The method of claim 20 wherein said services are selected from the group consisting of styling services; salon services, makeup services, nail trimming and coloring services, hair cutting and coloring services, massage services, and waxing services; personal shopping; health-related services, medical services, dental services, psychological services, nursing services, social work, and chiropractic services; athletic training, coaching, yoga, and Pilates; dance instruction; legal services; accounting services; child care services; laundry and cleaning services; travel services, advisement and booking reservation services; real estate services; food services; dietary services; appraisals; language services; financial services; check-cashing services; business services, secretarial services, copying, printing, faxing, scanning, wrapping, mailing, emailing, telephony, computer use; gift wrapping; financing purchases; returns; interior decoration; landscaping services; repair services; tailoring services; tutoring, educational services; career advisement, training services; religious services; chapel services; entertainment services; vending machines; and any combination thereof.

22. The method of claim 20 wherein said service comprises providing information about venue rest rooms and providing directional information to locate said rest rooms.

23. A method for displaying programming material to a user, comprising the steps of:
detecting a user communication device upon the communication device's arrival at a merchandising venue or commercial establishment;
receiving from the user communication device an indicated that the user has granted permission to transmit communication to the user communication device;
initiating communication by a merchandising server with the user communication device transmitting a greeting to the user communication device;
providing a menu of options to the user communication device for selection by the user;
receiving a selection of an option from the menu from the user communication device;
accessing programming material matching the selected option from a database;
transmitting from the database to the user communication device the programming material matching the selected option for display on a display of the user communication device.

24. The method of claim 23 wherein said menu options are selected from the group consisting of an electronic catalogue of available merchandise and/or services, information about sales and discounts, information about what is new in the venue, the opportunity to build a user profile, a browser window in which the user can enter his or her own search term, and any combinations thereof.

25. The method of claim 23 wherein the user communication device is selected from the group consisting of a hand-held communication device, a wireless communication device, a smart phone, a cellular telephone, a camera-enabled cellular telephone, virtual reality (VR) glasses, a wearable computer with an optical head-mounted display (OHMD), a personal digital assistant (PDA), an Internet-enabled telephone, a personal digital assistant, an Internet-enabled device, an intelligent terminal, a smart card, a personal computer, a tablet computer, a mini-tablet computer, a laptop computer, a device having a processor, and a device having any combination thereof.

26. The method of claim 23 wherein communication between the user communication device and the merchandising server is established via at least one data link that is recognized by the user communication device and the merchandising server.

27. The method of claim 23 wherein communication between the user communication device, the merchandising server, and the database is established via at least one data link that is recognized by the user communication device, the merchandising server, and said database, and any combination thereof.

28. The method of claim 26 wherein the data link is selected from the group consisting of an image data link, a video data link, an audio data link, a programming data link, an online data link, a pictorial data link, an electronic data link, an electronic media link, an “information superhighway” data link, the Internet, a computer network, a local area network, a wireless local area network, a Wi-Fi network, a wide area network, a wireless network, an Ethernet network, a Radio Frequency cellular network, Bluetooth, an Integrated Services Digital Network, a telephone line, a cable television line, and any combinations thereof.

29. The method of claim 23 wherein the database is selected from the group consisting of a local database, a remote database, a remote server, a network of databases, and any combination thereof.

30. The method of claim 23 wherein the display is coupled to the user communication device, is part of the user communication device, and any combination thereof.

31. The method of claim 23 wherein the user communication device has a processor.

32. The method of claim 23 wherein the merchandising venue or commercial establishment comprises a store, a retail store, a clothing store, a department store, a grocery store, a supermarket, an electronics store, an office supplies store, a convenience store, a bookstore, a wholesale distributor, a retail distributor, a theater, a stadium, a shopping mall, a museum, a gallery, a restaurant, a town or village commercial district, a street with a plurality of merchandising venues, and any combination thereof.

33. The method of claim 24 wherein the programming material transmitted from the database is related to a plurality of articles of merchandise and/or services.

34. The method of claim 33 wherein the plurality of articles of merchandise and/or services are displayed as a menu on the display unit associated with the user communication device, and further wherein the user can select at least one menu option to receive additional programming material.

35. The method of claim 34 wherein upon selection of an article of merchandise or a service, the user communication device receives and displays a sub-menu having a plurality of options selected from the group consisting of: availability of new merchandise or services; location of the merchandise or service in the merchandising venue; additional information about the merchandise or service; promotions and discounts associated with the merchandise and/or services, or with related merchandise and/or services; opportunity to purchase the merchandise and/or services; opportunity to have merchandise shipped to a location of the user's choosing, and any combinations thereof.

36. The method of claim 35 wherein the user selects the location of the merchandise or service, and is further presented with the option of having the venue track the user communication device's location in the venue and provide instructions to the user communication device for arriving at the location of the merchandise or service.

37. The method of claim 36 wherein said tracking is accomplished by means selected from the group consisting of Wi-Fi-based positioning (WPS), WLAN positioning, Bluetooth sensors, radio frequency (RF) communication, real-time locating systems (RTLS), GPS, NFC, triangulation or trilateration of signals from the consumer's device, long-range sensor positioning, optic, infrared or visible light, and acoustic, ultrasound. indoor positioning systems, ultra-wideband (UWB) positioning, and any combination thereof.

38. The method of claim 36 wherein said instructions are selected from a group consisting of audio instructions, continual audio instructions, a venue map with a highlighted route, a venue map with a continually updating highlighted route, a virtual display showing the updating highlighted route as from the vantage point of at least one eye of the user, and any combination thereof.

39. The method of claim 23 wherein said programming material is selected from the group consisting of advertising, information about the availability of merchandise or services, the location of the merchandise or service in the merchandising venue, additional information about the merchandise or service, information about related merchandise or services, information about discounts and promotions, information about the delivery of merchandise, information about the merchandising venue, contact information, and any combination thereof.

40. The method of claim 39 wherein said services include but are not limited to styling services; salon services, makeup services, nail trimming services, coloring services, hair cutting services, massage services, waxing services; personal shopping; health-related services, medical services, dental services, psychological services, nursing services, social work, chiropractic services; athletic training, coaching, yoga, and Pilates; dance instruction; legal services; accounting services; child care services; laundry services, cleaning services; travel services, advisement and booking reservation services; real estate services; food services; dietary services; appraisals; language services; financial services; check-cashing services; business services such as secretarial services, copying, printing, faxing, scanning, wrapping, mailing, emailing, telephony, computer use; gift wrapping; financing purchases; returns; interior decoration; landscaping services; repair services; tailoring services; tutoring services, educational services; career advisement and training services; career advisement services, training services; religious services; chapel services; entertainment services; vending machines; and any combination thereof.

41. The method of claim 39 wherein said services comprise providing information about venue rest rooms and providing directional information to locate said rest rooms.

42. A method for displaying programming material to a user, comprising the steps of:
storing a user profile comprising at least one user preference;
detecting the user communication device upon the communication device's arrival at a merchandising venue having a plurality of commercial establishments;
receiving by a merchandising server from the user communication device an indication that the user has granted permission to access the user profile and transmit communications to the user communication device;
initiating communication between the user communication device and the merchandising server;
accessing programming material stored in a database;
accessing the user profile;
matching the at least one user preference with programming material;
transmitting from the database to the user communication device the programming material that was matched with the at least one user preference for display on a display associated with a user communication device

43. The method of claim 42 wherein the plurality of commercial establishments are selected from a group consisting of a shopping mall, a town or village commercial district, a street with several shops, and any combination thereof.
